(19) United States
(12) Patent Application Publication
(10) Pub. No.: US 2010/0254432 A1
(43) Pub. Date: Oct. 7, 2010

(54) TRANSMITTER-EMITTER SYSTEM USING FREQUENCY HOPPING WITH UNIDIRECTIONAL COMMUNICATION

(75) Inventors: Fabrice Frebel, Wandre (BE); Bernard Manguette, Stembert (BE)

Correspondence Address: REINHART BOERNER VAN DEUREN P.C., 2215 PERRYGREEN WAY, ROCKFORD, IL, 61107, US

(73) Assignee: Charles Martin, Lantin (BE)

(21) Appl. No.: 12/417,987

(22) Filed: Apr. 3, 2009

(51) Int. Cl. H04B 1/00

(52) U.S. Cl. 375/136

(57) ABSTRACT

A communication method for transmitting a digital data sequence by a transmitter to a remote receiver, using frequency hopping spread spectrum, said data sequence comprising a plurality of blocks terminated by an end block, each block consisting of a plurality of consecutive data frames interspersed in time, each block being modulated at a carrier frequency belonging to a predetermined ordered hopset, the method comprising the steps of:
activating the data sequence transmission by pressing a switch located at the transmitter side;
transmitting the data sequence using the transmitter;
receiving and demodulating the data sequence at the receiver;
   wherein each data frame is provided with at least one additional bit so that to allow the receiver to determine either if the last received block is the end block of the sequence, or the time position of any frame inside each non-end block.

### FIELD OF THE INVENTION

The present invention is related to a method using a frequency hopping spread spectrum (FHSS) technique in an unidirectional communication. In the following it will be referred to as “frequency hopping.”

### BACKGROUND OF THE INVENTION

When commands have to be sent remotely, a radio-frequency transmitter-receiver system is typically used for this purpose. In this context, let us use a classical and very simple example of a dog handler who wants to send an instruction to a dog he wants to train. The handler uses a radio-frequency transmitter that can send an instruction to a collar attached on the neck of the dog. A typical instruction is for example an electrical stimulus of a given intensity.

As shown in FIG. 1, the transmitter is for example a small remote controller used by the handler to send an instruction. The receiver is for example a collar attached on the neck of a dog.

When the handler presses the S1 button, a coded radio-frequency signal is generated by the transmitter. When the receiver receives this coded radio-frequency signal, it generates an electrical stimulus. When the handler releases the S1 button, generation of the radio-frequency signal is halted and the receiver stops generating the electrical stimulus.

This dog handler example shows the need to remotely send instructions using radio-frequency. There are a lot of applications that use this way of operation and that should be considered as lying within the scope of the present invention. It should be noted that the distance between the dog and the handler can be very large (e.g. a few kilometres). Therefore, the transmitter can include a powerful radio-frequency amplifier.

### Transmitter-Receiver Operation

The coded radio-frequency signal is typically a frequency modulated signal that uses two frequencies located around a carrier frequency called f0. This is a narrow band modulation. These two frequencies are used to send digits 0 and 1 for encoding the instructions. FIG. 2 shows this operation.

FIG. 2 can be explained as follows. When the handler presses the S1 switch, the transmitter generates the coded frequency modulated radio-frequency signal to send an encoded “instruction” (or command) C1. Each encoded instruction is called a “frame” and is represented by a box on FIG. 2. Once an instruction has been sent, the transmitter is waiting during a short period and, if the S1 switch is still pressed, the transmitter sends a C1 instruction again and the process repeats as long as the S1 switch remains pressed.

This system has the advantage of being very simple because the transmitter and receiver are very simple components and the radio-frequency communication is one-way (or unidirectional). However, it has a lot of drawbacks. If two transmitters use the same frequency f0, interferences are possible as well. If an external radio-frequency device uses a frequency band that includes f0, interferences are possible. That means that a correct operation requires that the frequency band around f0 be absolutely free of interferences.

### Frequency Hopping

To circumvent the above problems, radio frequency data transmission systems often use a set of carrier frequencies: f0, f1, . . . , fN, instead of an unique carrier frequency f0. The transmitter and the receiver quickly (e.g. several times per second) change their carrier frequency in a pseudo-random way. In that way, if one carrier frequency is in a band that includes a lot of interference, only the data sent in that band are lost because communication can be maintained thanks to other frequencies.

This principle is called frequency hopping or frequency hopping spread spectrum (FHSS) and is a well-known technique that exists since tens of year (see FCC Regulation, PART 15—RADIO FREQUENCY DEVICES). The set of frequencies, f0, f1, . . . , fN, is called the “hopset.” The advantage of frequency hopping are:
its robustness for the communication even if a part of the spectrum has a lot of noise. Thanks to frequency hopping, the noisy part of the spectrum will only used for a small amount of time;
its ability to share a set of channels. This is possible if each transmitter-receiver pair does not use the same carrier frequency at the same time;
its security. It is practically impossible to track a signal that regularly changes its carrier frequency.

The problem to be solved in implementing frequency hopping is to find a way to force both the transmitter and the receiver to change their carrier frequency at the very same time. Changing at the very same time is a quite difficult task.

The basic principle for solving this synchronization issue is to use acknowledgements sent by the receiver to the transmitter. To perform this task, the transmitter and receiver use a radio-frequency transceiver that is able to send and receive radio-frequency signals. That means that communication has to be two ways (i.e. bidirectional: instruction sent from transmitter to receiver and acknowledgement sent from receiver to transmitter).

Frequency hopping has been widely used in radiofrequency network (e.g. WiFi), mobile phone, Bluetooth transmissions, etc.

Document U.S. Pat. No. 5,311,542 A discloses a spread spectrum communication system having a plurality of transmitters at remote locations capable of transmitting information to one or more receivers during a plurality of information time durations. A message structure interposing the plurality of information time durations with a plurality of preamble time durations, during which time the receiver detects message transmission, is also provided.

Document U.S. Pat. No. 6,535,544 B1 discloses a radio transmission system including many radio transmitters using frequency hopping carriers to intermittently transmit very short messages indicative of status of sensors associated with the transmitters. When activated, the transmitter transmits a message at one or several different frequencies. The frequencies are changed according to a predetermined algorithm and preferably differ for each subsequent transmission. Alternatively, when an abnormal sensor status is detected, the transmitter transmits repeated messages at a plurality of predetermined alarm frequencies for a predetermined time regardless of the time interval generator. The system also includes one or more receivers containing a plurality of memory registers to hold digital data indicative of (a) the time and (b) the frequency of the next transmission occurrence independently for each transmitter. The registers are programmed separately for each transmitter based on the time, frequency, and the content of the received messages.

Some attempts have been carried out to prevent lost data or enhance data reliability when some data frames are not received or when the carrier signals are blocked. For example, document US 2004/0001532 A1 discloses, in a frequency hopping spread spectrum receiver, a method of validating a transmitted signal, comprising: scanning a predetermined list of channels; checking a received signal strength indicator signal for each scanned channel; detecting a carrier signal on a selected channel; locking to said selected channel; and sampling for a start frame delimiter on said selected channel.

There are a lot of protocols used to synchronize a transmitter and a receiver. An example of protocol can be found in Frequency Hopping, Sem tech Application Note AN1200.03, March 2006.

### Problem to be Solved by the Invention

Unfortunately, for very simple applications like remote-controlled dog collars having a transceiver at both sides is space consuming and not cost effective at all, particularly if a radio-frequency power amplifier is needed (see above).

The purpose of the invention is to propose a robust method applied to a transmitter-receiver system that allows synchronization without the requirement of a two ways (bidirectional) communication channel. This would allow a simple transmitter-receiver system to take advantage of frequency hopping technique without additional hardware requirements.

It should also be noted that the transmitter can stop emitting at any time (when there are no more instructions to transmit) and the lack of feedback from the receiver could lead to the conclusion that frequency hopping cannot work in a system that is not capable of bidirectional communication.

A purpose of applying frequency hopping according to the present invention is that transmitter and receiver are kept synchronized even if no communication is possible on several frequencies of the “hopset,” the only condition being that they are not successive in the hop sequence.

It should be noted that the choice of the “hopset” and the hop sequence are also important and a lot of techniques (among which some of them are already patented) exist to determine and to dynamically adapt the “hopset” and the hop sequence. In the present invention, a classical pseudo-random hop sequence will be considered. Thus this is not the goal of the present invention to patent a “hopset” neither a hop sequence technique.

### SUMMARY OF THE INVENTION

The present invention relates to a communication method for transmitting a digital data sequence by a transmitter to a remote receiver, using frequency hopping spread spectrum, said data sequence comprising a plurality of blocks terminated by an end block, each block consisting of a plurality of consecutive data frames interspersed in time, each block being modulated at a carrier frequency belonging to a predetermined ordered hopset, the method comprising the steps of:
activating the data sequence transmission by pressing a switch located at the transmitter side;
transmitting the data sequence using the transmitter;
receiving and demodulating the data sequence at the receiver;
   wherein each data frame is provided with at least one additional bit so that to allow the receiver to determine either if the last received block is the end block of the sequence, or the time position of any frame inside each non-end block.

According to a feature of the invention, the data transmission is unidirectional and asynchronous.

According to another feature of the invention, the data sequence transmission is interrupted at any time by releasing the switch.

According to another feature, an end block is sent by the transmitter after the release of the switch.

According to another feature, the next block in the sequence is modulated at the carrier frequency which has the next order number in the hopset.

According to another feature, the transmission of a new data sequence is started once the switch is pressed again, the starting frequency being the same carrier frequency of the hopset that was used for transmitting the last block of the preceding sequence.

According to another feature, the receiver synchronizes with the transmitter by making smart guesses.

According to another feature, the smart guesses are selected from the group consisting of:
in the case of lost frames in a transmitted sequence, always knowing to which frequency the receiver should switch at the arrival of a new frame, thanks to the order number attached to the last frame received;
when the receiver receives a frame of an end block, knowing that the next block will start at the same frequency;
if all the frames of a block are not received at a given frequency, knowing that the receiver has to go to the next carrier frequency in the hopset, to wait during the time of a block reception and to resynchronize when the receiver again receives a frame; otherwise, knowing that the first block not received was an end block and that the receiver has also to wait for a new sequence at the next carrier frequency.

According to another feature, the receiver automatically builds a black list of carrier frequencies, the black list being used to check if the start of the next sequence is reliable enough.

According to another feature, the data transmission is bidirectional.

According to another feature, the receiver sends an acknowledgement code to the transmitter, every time it receives data frames at a given frequency.

Still according to the present invention, the remote communication is a radiofrequency, ultrasound or infrared carrier based communication.

Other aspects, objectives and advantages of the invention will become more apparent from the following detailed description when taken in conjunction with the accompanying drawings.

### BRIEF DESCRIPTION OF THE DRAWINGS

FIG. 1 already mentioned schematically represents a simple radiofrequency transmitter-receiver system.

FIG. 2 already mentioned schematically represents the transmission of instructions or frames using the system of FIG. 1.

FIG. 3 schematically represents the transmission of instruction blocks using the frequency hopping method according to the present invention.

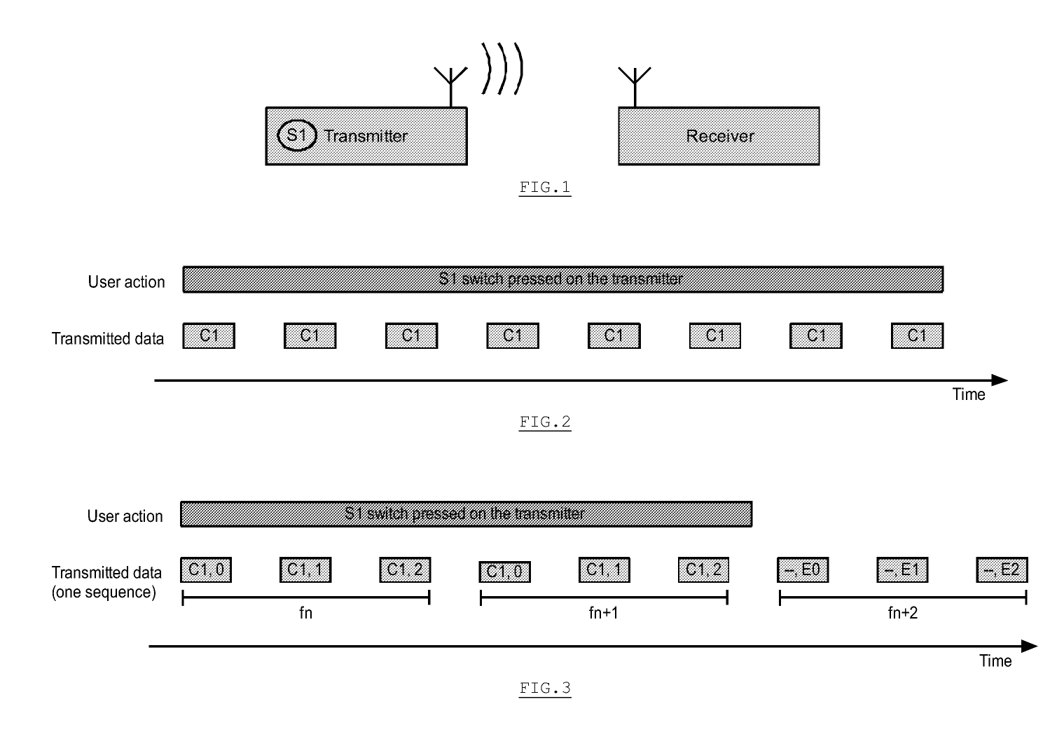

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENTS OF THE INVENTION

### Possible Principles

Within the context of the present invention, the principle used consists in sending a plurality of consecutive frames, called a “block” (for example three frames in FIG. 3) at one carrier frequency and then switching to the next carrier frequency. Switching from one carrier to another carrier (i.e. hopping) generally requires the transmitter and the receiver to be synchronized.

In a first unidirectional approach, synchronization could be maintained at the transmitter and at the receiver with two accurate synchronized reference clocks, a first one located in the transmitter and a second one located in the receiver. If carrier frequencies are defined in relation with theses clocks, the change from one carrier frequency to another carrier frequency can be synchronized in both the transmitter and the receiver.

There are two drawbacks thereof. First, the reference clock can drift slowly, that means that if there are no command sent during several hours, the transmitter and the receiver could loose synchronization. The second drawback is that two accurate reference clocks are needed in both the transmitter and the receiver. An accurate reference clock means a quartz-based clock that requires additional hardware and therefore additional cost and additional space. One should again note that the initial patent related to frequency hopping implicitly made the assumption that the transmitter and the receiver were synchronized that way (H. K. Markey et al., Secret Communication System, US-A-U.S. Pat. No. 2,292,387, 1942).

A second naive approach is to rely on the capability of the receiver to count frames in a block and then decide to change frequency when the last frame of the block is reached. This approach works well if there is no frame lost. However, when working with radio-frequency communication, frames can be lost owing to external perturbations. If a frame is lost, the receiver thus looses synchronization.

To solve the above problem, one can imagine an additional flag contained in the last frame of block that tells the receiver to change frequency for the next frame reception. This approach works well except if a frame is corrupted and if that corrupted frame is the one that tells to the receiver to change carrier frequency. Another problem is related to the uncertain behaviour of the receiver when the transmitter stops sending frames when the user releases the switch.

The present invention is therefore based on the use of a transmitter and a receiver with an associated method to operate them so that to allow the receiver to track the frequency change of the transmitter even if one or several frames are lost. An additional benefit of the invention will be its ability to quickly recover a synchronization loss.

### Preferred Principle

The principle of operation according to a preferred embodiment of the present invention is very simple and is related to the fact that the transmitter sends one (or a few) additional bit(s) in each frame. These additional bits contain information which helps the receiver to stay synchronized. The originality lies in the way this additional information is transmitted, allowing the receiver to keep synchronization even if several frames are lost.

Let us start with a few definitions. The set of frames sent at a given carrier frequency is called a “block,” as mentioned above. The duration of a block is called the “dwell time.” When the switch S1 is pressed, several blocks are sent. This set of block is called a “sequence.” An ordered set of allowed frequencies is called a “hopset”: f0, f1, . . . , fN. It should be noted that the value of f0, f1, . . . , fN is determined by a pseudo-random sequence. For example, f0=10, f1=8, f2=12, . . . , fN=7.

FIG. 3 shows a typical sequence.

The transmitter sends additional data in each frame. These data are indicated after the comma in each frame (FIG. 3):
one data indicates if the block is the last block of the sequence. It is indicated by a “E” (for end of the sequence);
in each block, a number is allocated to each frame to indicate its position inside the block.

It should be noted that very few bits are required to store this information. In the above case, we can imagine to use one bit to indicate the end of the sequence and two bits to indicate the position of the frame in the block (00=0, 01=1, 10=2).

The sequence sent by the transmitter must always have this format. When the switch S1 is released, one sees on FIG. 3 that the transmitter continues to send 3 frames (E frames) with no command, indicated by “______”. These frames are required because the sequence must always have the same format and because it is impossible to predict that the user will release the switch. One should note that the receiver will correctly react immediately when the switch is released. There is thus no loss of reactivity due to the three added frames.

The minimal sequence must at least contain one block: a sequence of only E frames is allowed.

Once the sequence is finished, if the user presses again the switch, a new sequence can start immediately just after frame E2 has been sent.

When the new sequence starts, the choice of the starting frequency is important. One possible solution is to use the next available frequency in the hopset after the frequency used for the last block (in the case of FIG. 3, it is fn+3). Another better solution is to use the frequency used for the last block (in the case of FIG. 3, it is fn+2).

With the above sequence definition, the receiver can take a lot of decisions to stay synchronized. An algorithm can be implemented in the receiver to take these decisions. It is not the purpose of this specification to detail such an algorithm but rather to explain the rules it has to follow to get the better possible synchronisation:
thanks to the number attached to each frame of a block, the receiver knows when it has to change the frequency. If a frame is lost, the receiver knows that it should have received a frame and can determine the time to switch with a relatively high accuracy (even if it has no accurate clock);
when the receiver receives an “end” frame (E-frame), it knows that the next block will be the start at the same frequency. At the end of the block, it knows that it has to stay at the same frequency;
if all the frames of a block are not received at frequency fx, the receiver knows that because the time for the reception of a block has expired and it should have received frames, it did not effectively receive frames. It has then to make a first guess:
   1) The receiver assumes that the sequence is still in progress and he did not receive a frame due to interference in a frequency band that disallow any frame to be sent in that frequency band. Therefore, the receiver goes to the next frequency (fx+1) band and waits during the length of one block. If the receiver receives again a frame, it can resynchronize accurately.
   2) If the receiver does not receive a frame after a block duration, it knows that the first guess was false. The first block it did not receive (at frequency fx) was actually an E-block and the receiver has to be prepared for a new sequence. The best action that the receiver can take is to stay at frequency fx+1 even if it knows that the new sequence will start at fx. The reason is that the receiver did not receive any frame of the block owing to interference. That means that frequency band around fx suffers from a lot of interference. Therefore, waiting at fx+1 maximize the chance to resynchronize on the new sequence.

One should finally note that, although the frames were numbered in a block in the example above, its is not mandatory. The above principle also works if the frames are not numbered. Numbering the frames in a block is more relevant when the blocks are large.

### Robustness Improvement

The robustness of the system can be again improved on the receiver side. During reception of several sequences, the receiver can learn that some blocks are not received in some frequency bands or that some frames are lost inside these blocks. The receiver can put these frequency bands into a black list and use this black list to determine that the start frequency for new sequence is not reliable enough.

The way of operation is again very simple. If the receiver determines that the frequency for the beginning of a new sequence is fn and that fn is in the black list, the receiver will choose fn+1 instead of fn to maximize the chance to get resynchronized on the new sequence.

Doing so, the receiver will loose the first block of the next sequence but it will accurately resynchronize on the next block.

### Initialization

The first time the transmitter and the receiver are powered up, it is required to synchronize them. Some mechanism, for example an initialization switch, can be implemented to allow the user to set the receiver in configuration mode. Once in configuration mode, the receiver waits for an instruction modulated with carrier f0.

The user presses a key for several seconds on the transmitter until the receiver get synchronized.

### Two-Ways Communication

The proposed method allows frequency hopping in a one-way communication. Once frequency hopping is correctly managed, it is perfectly possible to work in two ways communication using the carrier frequency determined by the proposed method.

However, bidirectional communication can be used to reinforce synchronization. Thanks to bidirectional communication, the transmitter knows that the receiver does not receive instructions anymore. It can therefore decide to restart sequence at the last frequency for which he got an acknowledgement from the receiver.

### ADVANTAGES OF THE INVENTION

The present invention provides a method carrying out a quite complex technique (i.e. frequency hopping), in a very simple application (i.e. transmitter-receiver system) and in a one way (i.e. unidirectional) communication. The invention allows to address the needs of a “light” communication application, while not requiring dedicated and expensive hardware.

In particular, the invention guarantees robustness thanks to the definition of blocks and sequences, intended to allow the receiver to make accurate guesses even if a lot of frames are lost.

Moreover the invention allows the receiver to be able to make its own black list without requiring bidirectional communication.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A communication method for transmitting a digital data sequence by a transmitter to a remote receiver, using frequency hopping spread spectrum, said data sequence comprising a plurality of blocks terminated by an end block, each block consisting of a plurality of consecutive data frames interspersed in time, each block being modulated at a carrier frequency belonging to a predetermined ordered hopset, the method comprising the steps of:
activating the data sequence transmission by pressing a switch located at the transmitter side;
transmitting the data sequence using the transmitter;
receiving and demodulating the data sequence at the receiver;
wherein each data frame is provided with at least one additional bit so that to allow the receiver to determine either if the last received block is the end block of the sequence, or the time position of any frame inside each non-end block.

2. The method of claim 1, wherein the data transmission is unidirectional and asynchronous.

3. The method of claim 1, wherein the data sequence transmission is interrupted at any time by releasing the switch.

4. The method of claim 3, wherein an end block is sent by the transmitter after the release of the switch.

5. The method of claim 1, wherein the next block in the sequence is modulated at the carrier frequency which has the next order number in the hopset.

6. The method of claim 1, wherein the transmission of a new data sequence is started once the switch is pressed again, the starting frequency being the same carrier frequency of the hopset that was used for transmitting the last block of the preceding sequence.

7. The method according to claim 1, wherein the receiver synchronizes with the transmitter by making smart guesses.

8. The method of claim 7, wherein the smart guesses are selected from the group consisting of:
in the case of lost frames in a transmitted sequence, always knowing to which frequency the receiver should switch at the arrival of a new frame, thanks to the order number attached to the last frame received;
when the receiver receives a frame of an end block, knowing that the next block will start at the same frequency;
if all the frames of a block are not received at a given frequency, knowing that the receiver has to go to the next carrier frequency in the hopset, to wait during the time of a block reception and to resynchronize when the receiver again receives a frame; otherwise, knowing that the first block not received was an end block and that the receiver has also to wait for a new sequence at the next carrier frequency.

9. The method of claim 1, wherein the receiver automatically builds a black list of carrier frequencies, the black list being used to check if the start of the next sequence is reliable enough.

10. The method of claim 1, wherein the data transmission is bidirectional.

11. The method of claim 10, wherein the receiver sends an acknowledgement code to the transmitter, every time it receives data frames at a given frequency.

12. The method of claim 1, wherein the remote communication is a radiofrequency, ultrasound or infrared carrier based communication.
